(19) United States
(12) Patent Application Publication
(10) Pub. No.: US 2006/0064335 A1
(43) Pub. Date: Mar. 23, 2006

(54) Method, system, and storage medium for performing business process modeling

(75) Inventors: German Sergio Goldszmidt, Dobbs Ferry, NY (US); Joshy Joseph, Poughkeepsie, NY (US); James G. Massie, Hinsdale, IL (US); Lance Walker, Boulder, CO (US)

Correspondence Address: Philmore H. Colburn II;Cantor Colburn LLP, 55 Griffin Road South, Bloomfield, CT, 06002, US

(73) Assignee: INTERNATIONAL BUSINESS MACHINES CORPORATION, ARMONK, NY (US)

(21) Appl. No.: 10/919,913

(22) Filed: Aug. 17, 2004

(51) Int. Cl. G06F 17/50

(52) U.S. Cl. 705/7

(57) ABSTRACT

Exemplary embodiments include a method for performing business process modeling. The method includes identifying capabilities, activities, and requirements associated with a business problem or an opportunity. The activities are operable for implementing the capabilities and the capabilities are operable for resolving the business problem or exploiting the opportunity. For each of the activities, the method includes selecting at least one corresponding process module that includes listings of attributes applicable to the activities, selecting at least one of the attributes from the listings, and defining transition artifacts for integrating selected process modules. The method also includes compiling the transition artifacts, selected attributes, and selected activities with corresponding process modules, and generating a business process model as a result of the compilation.

### BACKGROUND OF THE INVENTION

The invention relates generally to business process modeling and, more particularly, to performing business process modeling using reusable business process modules and information technology components.

Organizations develop business models in order to create, organize, and implement business plans which solve problems or exploit business opportunities. Due to various factors, however, either anticipated or unforeseen, it is often difficult to satisfactorily develop and implement a business plan using these models. For example, very often an enterprise will need to re-strategize as a result of changes in marketplace conditions, customer demand, governmental regulations, economic factors, and technology requirements, to name a few. Oftentimes, these businesses find that they are unable to change their business processes and enabling information technology (IT) applications/infrastructure fast enough to keep pace with these changing conditions, nor are they able to dynamically adapt their processes or applications for on demand responsiveness.

It would be desirable to create a modular business process model artifact that can be efficiently transformed into an operational workflow that is capable of solving targeted business problems.

### BRIEF SUMMARY OF THE INVENTION

Exemplary embodiments include a method for performing business process modeling. The method includes identifying capabilities, activities, and requirements associated with a business problem or an opportunity. The activities are operable for implementing the capabilities and the capabilities are operable for resolving the business problem or exploiting the opportunity. For each of the activities, the method includes selecting at least one corresponding process module that includes listings of attributes applicable to the activities, selecting at least one of the attributes from the listings, and defining transition artifacts for integrating selected process modules. The method also includes compiling the transition artifacts, selected attributes, and selected activities with corresponding process modules, and generating a business process model as a result of the compilation.

Exemplary embodiments also include a system for performing business process modeling. The system includes a user system including a processor. The user system is in communication with a storage device. The storage device stores pre-defined process modules, attributes, and metadata accessible to a user system. The system also includes a process model configurator application executing on the user system. The process model configurator application prompts a user of the user system to provide inputs. The inputs include capabilities, activities, and requirements associated with a business problem or an opportunity. The activities are operable for implementing the capabilities and the capabilities, in turn, are operable for resolving the business problem or exploiting the opportunity. For each of the activities, the process model configurator application prompts the user to select at least one corresponding process module that includes listings of attributes applicable to the activities. In response to selecting at least one corresponding process module, the process module configurator application prompts the user to select at least one of the attributes from the listings and define transition artifacts operable for integrating process modules. In response to the inputs, the process module configurator application compiles the transition artifacts, selected attributes, and selected activities with corresponding process modules. As a result of the compiling, the process module configurator application generates a business process model.

Other methods, systems, and computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system for implementing the process model configurator in exemplary embodiments;

FIG. 2 is a graphical representation of the process module attributes in exemplary embodiments;

FIG. 3 is a flow diagram of a process for implementing the process model configurator in exemplary embodiments of the invention;

FIG. 4 is a user interface screen illustrating a sample main menu for accessing the features provided by the process model configurator in exemplary embodiments; and

FIG. 5 is a user interface screen illustrating a sample process module and attribute selection window for creating a process model in exemplary embodiments.

### DETAILED DESCRIPTION

The process model configurator defines a sequence of steps using multiple artifacts (e.g., process modules, metadata, attributes, etc.) to create a modular business process model artifact that can be efficiently transformed into an operational workflow that solves specific business problems for a given business scope. The resulting business model incorporates a sufficient level of construct information including references to IT components, data, business rules, and other elements to enable its mapping to an executable workflow.

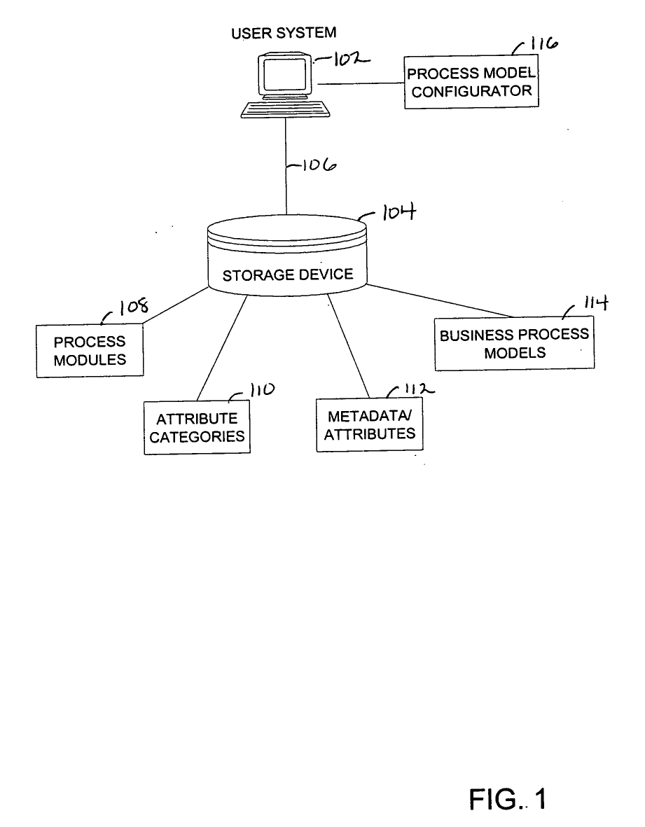

Turning now to FIG. 1, a system upon which the process model configurator may be implemented in exemplary embodiments will now be described. The system of FIG. 1 includes a user system 102 in communication with a storage device 104 via a connection 106. User system 102 may be implemented using a general-purpose computer executing a computer program for carrying out the processes described herein. The user system 102 may be a personal computer (e.g., a lap top, a personal digital assistant). Connection 106 may be a wireline cable, communications network (e.g., a local area network), or similar means of connection. In alternate embodiments, connection 106 may be a wireless connection. In yet further embodiments, user system 102 may be remotely located from storage device 104.

Storage device 104 may be implemented using a variety of devices for storing electronic information. It is understood that the storage device 104 may be implemented using memory contained in the user system 102 or it may be a separate physical device. If connection 106 is a network, then storage device 104 may be logically addressable as a consolidated data source across a distributed environment that includes network 110. Information stored in storage device 104 may be retrieved and manipulated via the user system 102.

It will be understood that user system 102 and storage device 104 may comprise a single unit whereby user system 102 contains sufficient memory to store the data and information utilized by the process model configurator system. The system of FIG. 1 illustrates these as two separate components for ease of explanation and is not to be construed as limiting in scope.

An individual on user system 102 may implement the process model configurator as described herein via an application executing on the user system. The process model configurator application 116 may employ a standardized modeling language application for facilitating the design and workflow processes associated with a business process. For example, Business Process Execution Language (BPEL) uses a combination of web services to enable task sharing in a distributed (or grid) environment.

Storage device 104 stores process modules 108 utilized by the process model configurator application 1 16. Process modules 108 refer to pre-designed, reusable, sub-processes, which may be assembled from larger scope business process models.

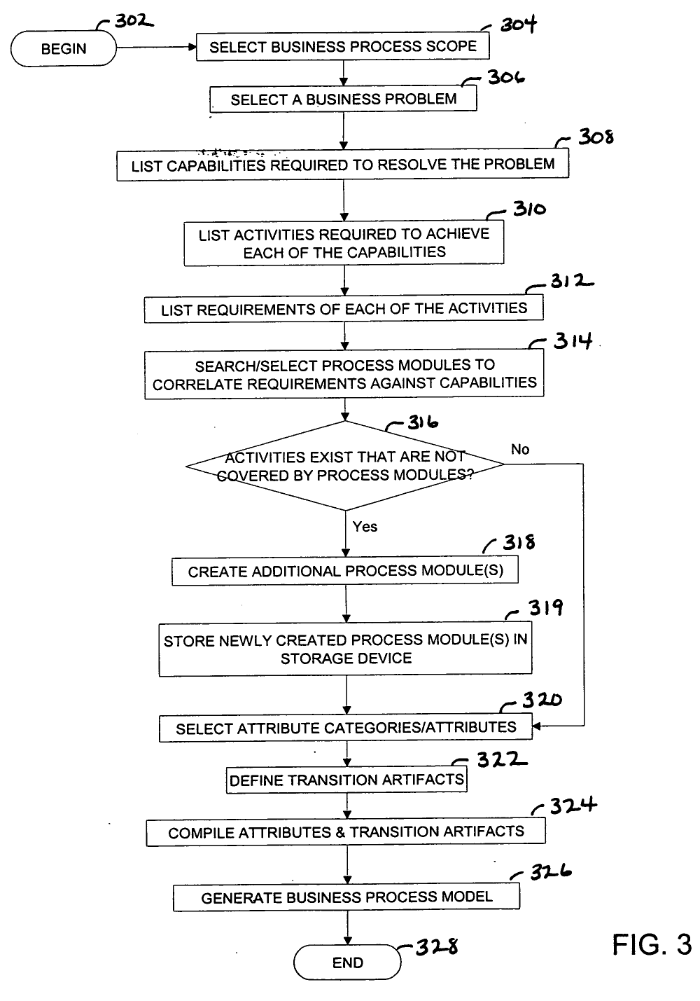

Process modules 108 consolidate and codify often-repeated business activities into reusable, best practice designs. Process modules are designed for configurable adaptability, which enable them to be applied within multiple business processes and across multiple business organizations. Design and configuration governance is used to establish and maintain process module cross-organizational value and reusability. A user may create new process modules for activities that are not addressed by existing process modules. This functionality is described further in FIG. 3.

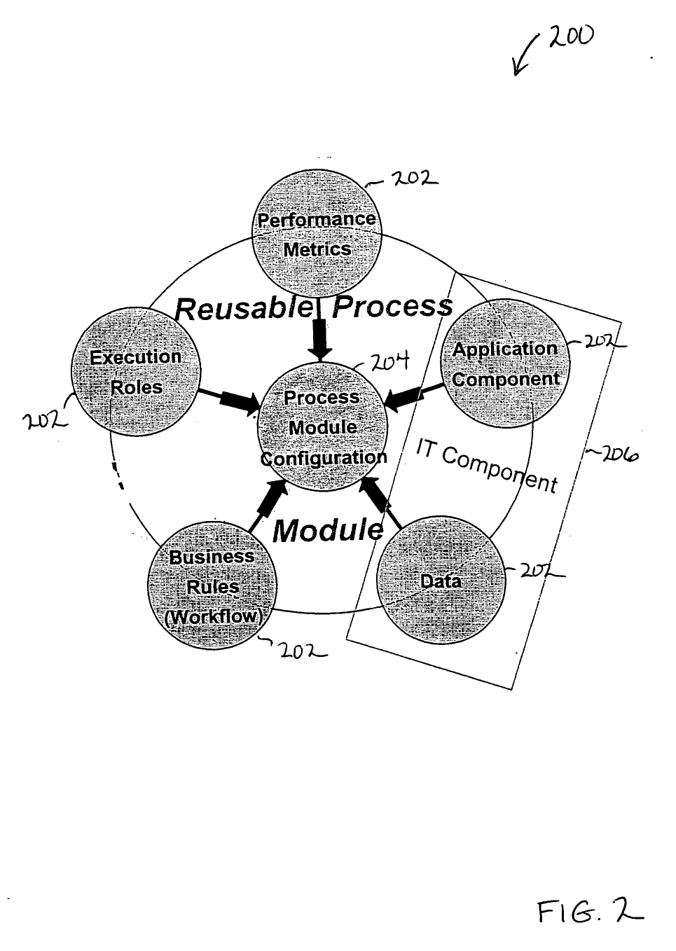

Storage device 104 also stores configurable attribute categories that include: application, data, roles, rules, and metrics. These are described further in FIG. 2.

Storage device 104 also stores metadata and attributes 112 utilized by the process model configurator application 116. The metadata and attributes describe the functional capabilities provided by each process module, as well as the business and technical contexts into which the process modules have been or might be used. Transition artifacts may also be stored in storage device 104 and are described further herein.

Business process models 114 may also be stored in storage device 108. Business process models 114 refer to the output or final product realized as a result of implementing the process model configurator application 116. These process models 114 may be used to generate and implement a detailed workflow for execution.

Turning now to FIG. 2, a graphical representation 200 of the process module and its attributes will now be described. The circles 202 represent attribute categories used by the process model configurator application 116 (the details about the algorithm used by configurator will be described in FIG. 3) in creating and/or modifying business process models. These attribute categories enable the same process module design 204 to be easily and rapidly adapted, as needed, for reuse in new or other existing solutions. The attribute categories provide pre-defined attributes available for association with one or more applicable process modules selected by an individual when creating a business process model. The application and data components together provide pre-defined information technology attributes 206. A user selects attributes from these attribute categories 202 in order to satisfy an activity requirement selected for use in creating a business process model.

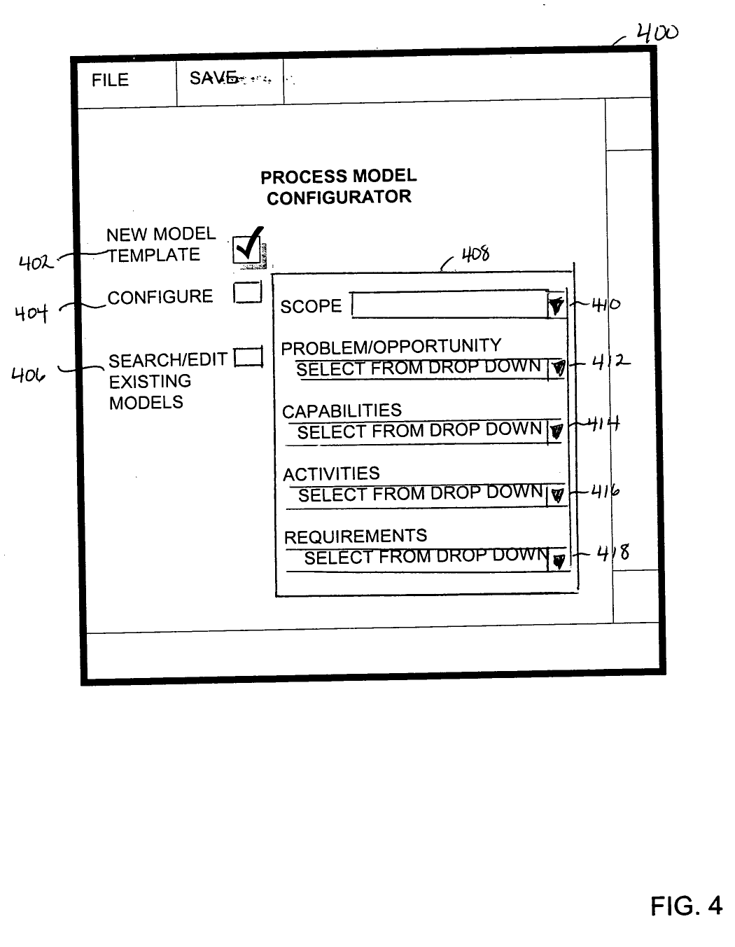

Turning now to FIG. 3, a flow diagram of a process for implementing the process model configurator application 116 in accordance with an exemplary embodiment will now be described. The process begins at step 302 whereby a user accesses the process model configurator application 116 a user interface screen such as the sample screen of FIG. 4 and main menu are presented to the user. The user interface screen 400 of FIG. 4 illustrates three menu options. New model template option 402 causes the process model configurator application 116 to provide a template for entering data relating to the business problem to be solved or opportunity to be exploited. By selecting the configure option 404, the user is prompted to search storage device 104 for specific process modules that relate to the data entered via option 402. Search/edit existing models option 406 enables a user to search storage device 104 for existing business process models 114 for viewing, modification, etc.

As shown in FIG. 4, the user has selected option 402. The process model configurator 116 presents a subwindow 408 and prompts the user to enter information as described herein. While drop down boxes are shown in screen 400, it will be understood that text boxes for data entry may be provided in lieu of, or in combination with, the drop down boxes in order to realize the advantages of the invention.

The user is prompted to enter a business process scope from drop down field 410 at step 304. The business process scope refers to a general category applicable to the subject to be addressed in the business model. For example, a user might select “Sales Solution Configuration” as the business process scope to be addressed.

Once the scope has been selected, the user identifies a specific business problem or opportunity from field 412 at step 306. For example, within the scope “Sales Solution Configuration” the user may select an item “Lack of Web Accessible Product Configuration” as the specific problem to be addressed. At step 308, the user is prompted to select one or more capabilities that resolve or address the specific problem previously selected in step 306. Using the above example, the user might select “Able to Change Product Configuration by Web Access” from drop down box 414 as one capability.

At step 310, the user is prompted to select the activities required to achieve each of the capabilities selected in step 308 from drop down box 416. Continuing with the above example, the user selects “Login to System” from the drop down box 416. For purposes of illustration, it is assumed that a process module does not exist for “Change Product Configuration.” The user then proceeds to step 312 and enters the requirements for the “Log into System” activity using drop down box 418. For example, requirements for this activity may include “User ID and password must be used as the authentication credentials” and “Authentication Credential Must Follow the Required Minimum Length for Password.”

Once this information has been entered, the user selects the configure option 404 and the process model configurator application 116 searches process modules 108 in storage device 108 to identify those modules that relate to the information entered by the user at step 314. The process model configurator application 116 determines which activities have corresponding process modules, and which do not, at step 316. Continuing with the above example, because the activity “Change Production Configuration” did not have a corresponding process module, the process model configurator application 116 prompts the user to create one at step 318. The newly created process module is stored in storage device 108 at step 319. If, on the other hand, all of the activities specified have been addressed by process modules, the method would continue at step 320.

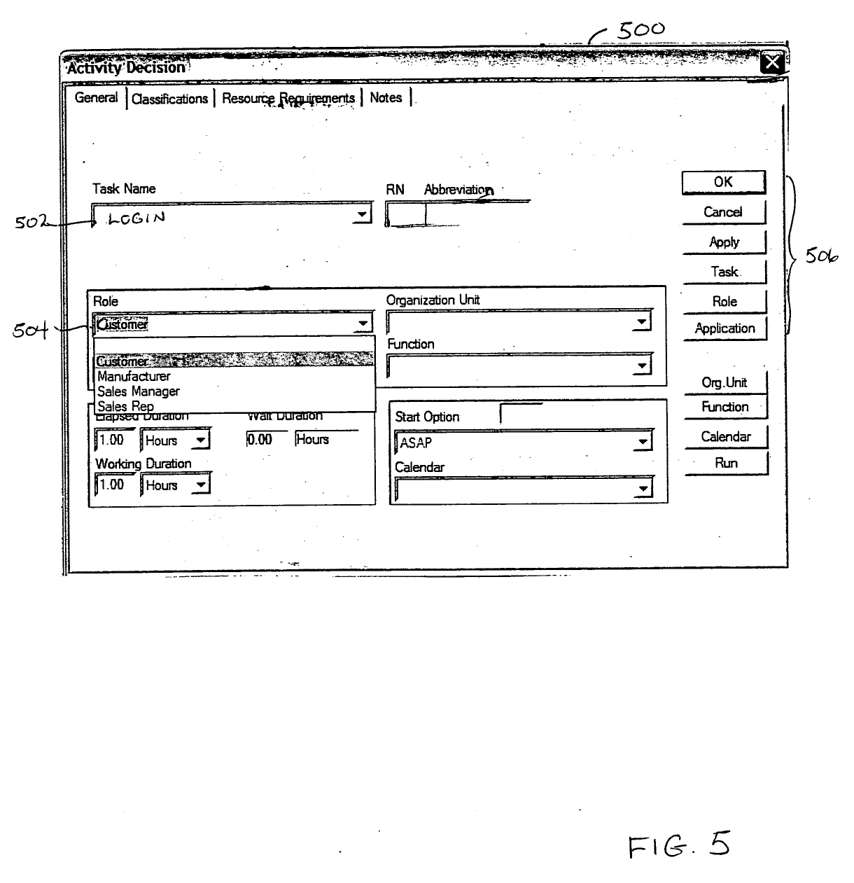

Once the requirements for these activities have been associated with process modules, the user is prompted to select from attributes available that are provided by each process module selected in step 314 and which relate to the business problem to be addressed at step 320. A user interface screen 500 illustrating a sample process module and attribute listing is provided generally in FIG. 5. As shown in FIG. 5, the process module selected addresses the login activity (see field 502). User interface screen 500 also includes the available attributes for selection (e.g., Customer, Manufacturer, Sales Manager, Sales Rep) that relate to the attribute category “Role.” The user has selected the attribute “Customer” as shown in field 504.

Once the user has completed entering the attributes for the categories defined by the selected process module, the user is prompted to define any transition artifacts at step 322. Transition artifacts relate to information or requirements that enable integration of all process modules that were selected and configured by the user in the above process steps. Using the above example, a user might define the transition artifacts between “Login” and “Change Product Configuration” as: a condition such that if Login completes with authentication failure, exit the process, else start change product configuration with the corresponding authentication credentials as input. Upon completion of the transition artifacts, the process model configurator application 116 compiles the process modules, selected attributes, and transition artifacts at step 324 and generates a business process model at step 326. The process ends at step 328.

The process model configurator defines a sequence of steps using multiple artifacts (e.g., process modules, metadata, attributes, etc.) to create a modular business process model artifact that can be efficiently transformed into an operational workflow that solves specific business problems for a given business scope. The resulting business model incorporates a sufficient level of construct information including references to IT components, data, business rules, and other elements to enable its mapping to an executable workflow.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for performing business process modeling, comprising:
identifying capabilities, activities, and requirements associated with a business problem or an opportunity, the activities operable for implementing the capabilities, the capabilities operable for resolving the business problem or exploiting the opportunity;
for each of the activities, selecting at least one corresponding process module including listings of attributes applicable to the activities;
selecting at least one of the attributes from the listings;
defining transition artifacts operable for integrating selected process modules;
compiling the transition artifacts, selected attributes, and selected activities with corresponding process modules; and
as a result of the compiling, generating a business process model.

2. The method of claim 1, wherein the attributes are organized into categories including:
role;
application;
metrics;
data; and
rules.

3. The method of claim 2, wherein the attributes associated with the application and the data are combined to define information technology attributes.

4. The method of claim 1, further comprising:
generating a process module for activities selected and unaddressed by existing process modules; and
storing the generated process module in a repository.

5. The method of claim 1, wherein the business problem or opportunity is associated with a business process scope, the business process scope including a general category applicable to a subject to be addressed in the business process model.

6. The method of claim 1, wherein the at least one process module includes pre-designed, reusable sub-processes.

7. The method of claim 1, further comprising:
transforming the business process model into an executable operational workflow.

8. A storage medium encoded with machine-readable program code for performing business process modeling, the program code including instructions for causing a processor to implement a method, comprising:
identifying capabilities, activities, and requirements associated with a business problem or an opportunity, the activities operable for implementing the capabilities, the capabilities operable for resolving the business problem or exploiting the opportunity;
for each of the activities, selecting at least one corresponding process module, the at least one corresponding process module including listings of attributes applicable to the activities;
selecting at least one of the attributes from the listings;
defining transition artifacts operable for integrating process modules;
compiling the transition artifacts, selected attributes, and selected activities with corresponding process modules; and
as a result of the compiling, generating a business process model.

9. The storage medium of claim 8, wherein the attributes are organized into categories including:
role;
application;
metrics;
data; and
rules.

10. The storage medium of claim 9, wherein the attributes associated with the application and the data are combined to define information technology attributes.

11. The storage medium of claim 8, further comprising instructions for causing the processor to implement:
generating a process module for activities selected and unaddressed by existing process modules; and
storing the generated process module in a repository.

12. The storage medium of claim 8, wherein the business problem or opportunity is associated with a business process scope, the business process scope including a general category applicable to a subject to be addressed in the business process model.

13. The storage medium of claim 8, wherein the at least one process module includes pre-designed, reusable sub-processes.

14. The storage medium of claim 8, further comprising instructions for causing the processor to implement:
transforming the business process model into an executable operational workflow.

15. A system for performing business process modeling, comprising:
a user system including a processor, the user system in communication with a storage device, the storage device storing pre-defined process modules, attributes, and metadata accessible to a user system;
a process model configurator application executing on the user system, the process model configurator application prompting a user of the user system to provide inputs, the inputs including capabilities, activities, and requirements associated with a business problem or an opportunity, the activities operable for implementing the capabilities, the capabilities operable for resolving the business problem or exploiting the opportunity;
for each of the activities, the process model configurator application prompts the user to select at least one corresponding process module, the at least one corresponding process module including listings of attributes applicable to the activities;
in response to selecting at least one corresponding process module, the process module configurator application prompts the user to select at least one of the attributes from the listings and define transition artifacts operable for integrating process modules; and
in response to the inputs, the process module configurator application performs:
compiling the transition artifacts, selected attributes, and selected activities with corresponding process modules; and
as a result of the compiling, generating a business process model.

16. The system of claim 15, wherein the attributes are organized into categories including:
role;
application;
metrics;
data; and
rules.

17. The system of claim 16, wherein the attributes associated with the application and the data are combined to define information technology attributes.

18. The method of claim 15, wherein the process module configurator application further performs:
generating a process module for activities selected and unaddressed by existing process modules; and
storing the generated process module in a repository.

19. The system of claim 15, wherein the business problem or opportunity is associated with a business process scope, the business process scope including a general category applicable to a subject to be addressed in the business process model.

20. The system of claim 15, wherein the at least one process module includes pre-designed, reusable sub-processes.
